(19) United States
(12) Patent Application Publication
(10) Pub. No.: US 2012/0224070 A1
(43) Pub. Date: Sep. 6, 2012

(54) Eyeglasses with Integrated Camera for Video Streaming

(75) Inventors: Brent Burroff, (US); Evan Lindquist, (US); Carlos Becerra, Seattle, WA (US); Joe Taylor, (US); Pieris Berreitter, (US)

(73) Assignee: ZionEyez, LLC

(21) Appl. No.: 13/411,270

(22) Filed: Mar. 2, 2012

Related U.S. Application Data
(60) Provisional application No. 61/449,594, filed on Mar. 4, 2011.

(51) Int. Cl. H04N 5/225

(52) U.S. Cl. 348/207.1; 348/376; 348/333.01; 348/E05.024; 348/E05.025

(57) ABSTRACT

A camera is integrated into eyeglasses to allow hands-free recording of video or still images. The eyeglasses also include electronic components, such as a processor for encoding the video and a radio for transmitting the video. The eyeglasses may stream the video to a server, where the video may be viewed my other users. The eyeglasses may connect to a cellular data network to stream the data or connect to a nearby mobile device that relays the streaming video to the cellular data network. The size of the eyeglasses with the integrated camera may be reduced by overmolding wiring and/or electronic components into temples of the frame and coupling components with the integrated camera through the temples and the front frame of the eyeglasses.

### CROSS-REFERENCE TO RELATED APPLICATIONS

This application claims priority to U.S. Provisional Patent Application No. 61/449,594 to Brent Burroff et al. filed on Mar. 4, 2011, and entitled “Eyeglasses for Streaming Live Video to the Internet,” which is hereby incorporated by reference in its entirety.

### FIELD OF THE INVENTION

The instant disclosure relates to video recorders. The instant disclosure more specifically relates to highly portable video recorders with social media integration.

### BACKGROUND

Social media provides an opportunity for sharing an individual's daily experience with friends and family. However, interaction with friends and family through social media is not real time. An individual captures his experience in pictures or thoughts and then writes about the experience after the event by writing a post for an Internet site or uploading photographs from his camera. Thus, interaction with friends and family through social media is not real-time.

Further, capturing photographs or videos for later sharing on a social media website can remove an individual from the experiences occurring around him. For example, to capture video of a child's soccer game, a parent must stand on the sidelines holding a video camera. The recording activity forces the parent out of the game and prevents her from taking part in the game. Thus, the desire to share an individual's experience with friends and family can diminish the individual's experience.

U.S. Patent Publication No. 2010/0245585 to Fisher et al. discloses an earpiece-mounted video camera. The earpiece may be attached to a pair of glasses for wearing by an individual. However, the electronic components associated with the video camera are housed in the earpiece-mounted container rather than the eyeglasses. Thus, the video camera of Fisher is bulky and obtrusive.

U.S. Pat. No. 7,806,525 to Howell et al. discloses a pair of eyeglasses having a camera and other electronic components. However, Howell does not disclose that electronic components may be embedded in both temples of the eyeglasses and connected together through the front frame. Thus, Howell is limited in the amount of functionality that may be incorporated to the eyeglasses without significantly impacting the appearance of the glasses by making the one temple significantly bulkier and more obtrusive.

### SUMMARY

A video camera may be integrated into a pair of eyeglasses to facilitate involvement in activities and improve interaction with the environment. For example, the video camera may be integrated into a pair of eyeglasses so as to not extrude from the eyeglasses. According to one embodiment, the integration is accomplished through overmolding wiring into parts of the eyeglasses. Video may be streamed through the eyeglasses to a cloud-based video sharing system through one or more wireless connections. According to one embodiment, the video is streamed first to a mobile device and then to the cloud-based video sharing system.

The video recording capability of the eyeglasses may also improve interactivity by the wearer with the environment. For example, the video camera may record objects around the eyeglasses wearer, upload the recordings to the cloud-based video sharing system, and receive data regarding objects recorded by the video camera. According to one embodiment, the received data is advertisements related to objects in the eyeglass wearer's view.

In another example, the video camera may record gestures made by the eyeglasses wearer. The gestures may be converted into commands that are relayed to electronic devices. According to one embodiment, the gestures may be used by the eyeglasses wearer to control the display of a presentation.

According to one embodiment, an apparatus includes an eyeglasses frame having a first temple and a second temple, each connected to a front frame through hinges. The apparatus also includes a video recorder integrated into a corner of the front frame. The apparatus further includes electronic components coupled to the video recorder and attached to the first temple and the second temple. The apparatus also includes a wire coupling electronic components in the first temple with electronic components in the second temple, the wire running through the first temple, the hinges, the front frame, and the second temple. The wire is overmolded into at least the front frame.

According to another embodiment, a method includes establishing communications over a first wireless connection between a mobile device and eyeglasses with an integrated camera. The method also includes establishing communications over a second wireless connection between the mobile device and the eyeglasses by communicating through the first wireless connection. The method further includes transmitting at least one video or at least one image through the second wireless connection from the eyeglasses to the mobile device.

According to a further embodiment, a computer program product includes a non-transitory computer-readable medium having code to establish communications over a first wireless connection between a mobile device and eyeglasses with an integrated camera. The medium also includes code to establish communications over a second wireless connection between the mobile device and the eyeglasses by communicating through the first wireless connection. The medium further includes code to transmit at least one video or at least one image through the second wireless connection from the eyeglasses to the mobile device.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is an exploded perspective view of components of eyeglasses with an integrated camera according to one embodiment of the disclosure.

FIG. 2 is a front perspective view of eyeglasses with an integrated camera according to one embodiment of the disclosure.

FIG. 3 is a top view of a side frame of eyeglasses with an integrated camera according to one embodiment of the disclosure.

FIG. 4 is a rear perspective view of eyeglasses with an integrated camera according to one embodiment of the disclosure.

FIG. 5 is a side perspective view of eyeglasses with an integrated camera according to one embodiment of the disclosure.

FIG. 6 is a top perspective view of eyeglasses with an integrated camera according to one embodiment of the disclosure.

FIG. 7 is a perspective view of eyeglasses with an integrated camera according to one embodiment of the disclosure.

FIG. 8 is a block diagram illustrating electronics for eyeglasses with an integrated camera according to one embodiment of the disclosure.

FIG. 9 is a block diagram illustrating a wireless connection between eyeglasses with an integrated camera and a cellular phone according to one embodiment of the disclosure.

FIG. 10 is a flow chart illustrating a method of connecting and transferring video from eyeglasses with an integrated camera to a cellular phone according to one embodiment of the disclosure.

FIG. 11 is a block diagram illustrating a computer system or mobile computing device according to one embodiment of the disclosure.

FIG. 12 is a drawing illustrating a method of controlling a video camera integrated into eyeglasses according to one embodiment of the disclosure.

FIG. 13 is a flow chart illustrating a method of controlling a video camera integrated into eyeglasses according to one embodiment of the disclosure.

FIG. 14 is a drawing illustrating a method of controlling a video presentation through a video camera integrated into eyeglasses according to one embodiment of the disclosure.

FIG. 15 is a flow chart illustrating a method of controlling a video presentation through a video camera integrated into eyeglasses according to one embodiment of the disclosure.

FIG. 16 is a drawing illustrating a method of analyzing product information with a video camera integrated into eyeglasses according to one embodiment of the disclosure.

FIG. 17 is a flow chart illustrating a method of analyzing product information with a video camera integrated into eyeglasses according to one embodiment of the disclosure.

FIG. 18 is a flow chart illustrating a method of providing advertisements to a user based on images captured by a camera integrated into eyeglasses according to one embodiment of the disclosure.

### DETAILED DESCRIPTION

A camera may be integrated into an eyeglasses frame to improve a user's ability to record events around him without removing himself from the event. The eyeglasses with integrated camera may increase the quantity and quality of images and video shared through social media web sites. For example, a parent can record a child's soccer game without standing on the sideline holding a bulky camcorder. However, the eyeglasses with integrated camera are not limited to social media uses. The integrated camera may be useful in many other situations, such as recording law enforcement activity, surveying military theatres, quality checking construction sites, and recording safety information in an airplane cockpit.

The eyeglasses with integrated camera may include local storage and/or a wireless transmitter. Thus, images and video may be recorded and stored for download to another device later. Additionally, images and video may be streamed from the integrated camera in the eyeglasses to another location, such as a mobile phone or server, where the images and video may be processed or stored. The recorded images and video also present an additional opportunity for providing information to the eyeglasses wearer. After processing the images and video recorded by the integrated camera, information may be provided to the user regarding objects in the recorded images and video. For example, when a product is identified in the images and video, specifications about the product may be relayed to the user's mobile device. In another example, advertisements for the product, including a coupon, may be relayed to the user's mobile device for display to the user.

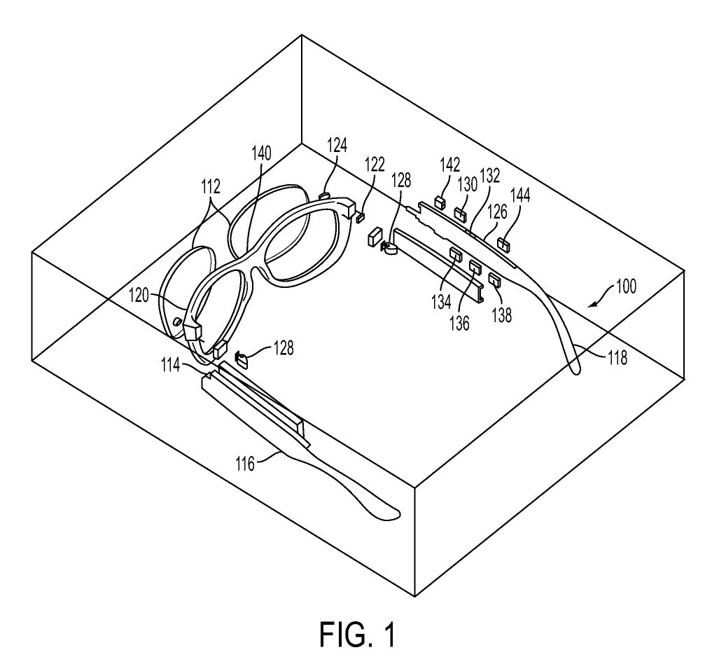

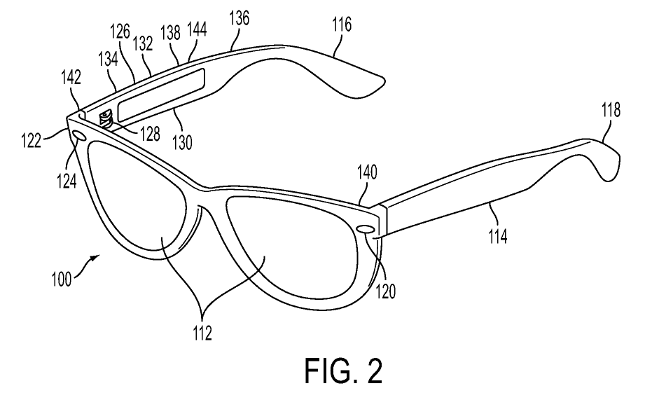

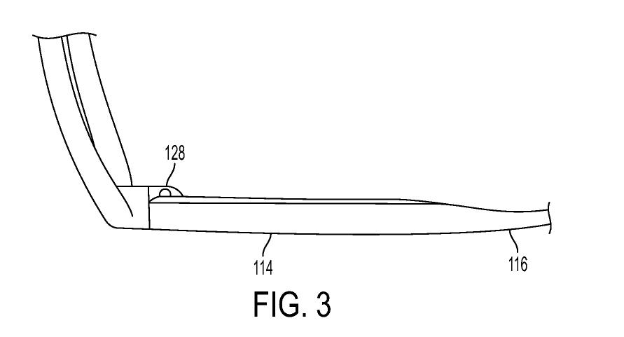

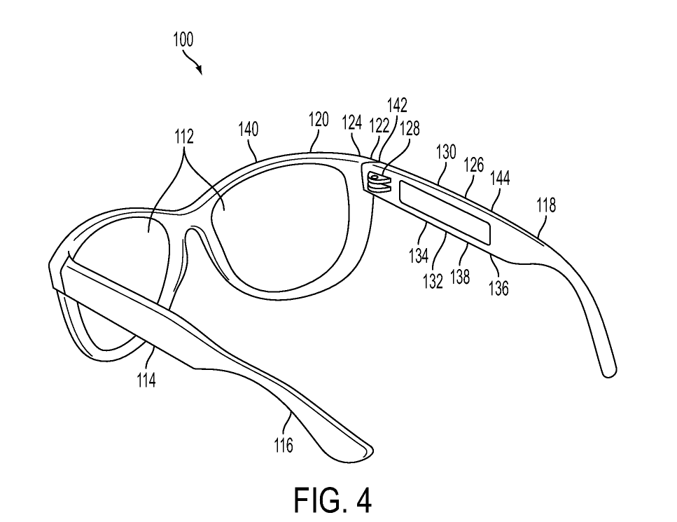

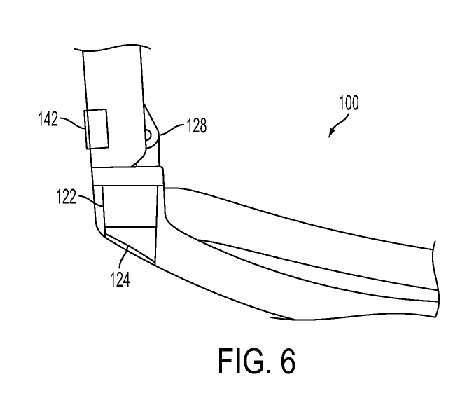

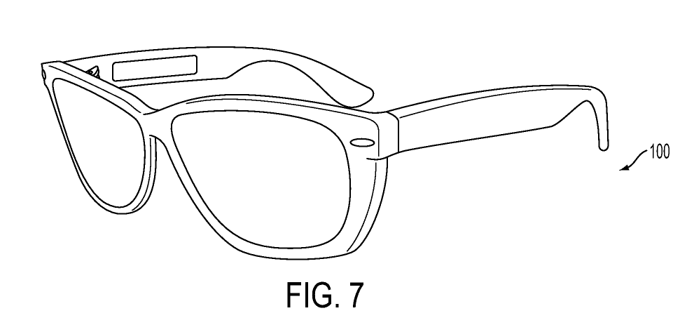

FIGS. 1-7 illustrate eyeglasses with an integrated camera according to one embodiment of the disclosure according to several views. Eyeglasses 100 may include lenses 112, which may be removable or fixed. According to different embodiments, the lenses 112 may be clear, shaded, or prescription lenses that snap in and out of a front frame 120 of the eyeglasses 100. The eyeglasses 100 may also include a battery 114, a left temple 116, a right temple 118, a video recorder 122, a recorder lens 124, a circuit board 126, hinges 128, a wireless transmitter 130, a data storage port 132, an audio recorder 134, a microprocessor 136, memory 138, a wire 140, a logo 142, and a graphics processor 144. The hinges 128 connect the left temple 160 and the right temple 180 to the front frame 120 of the eyeglasses 100. Although only one wire is illustrated for the wire 140, the wire 140 may comprise multiple wires or multiple segments of wires coupling the electronic components.

Electronic components, such as the wireless transmitter 130, the video recorder 122, the microprocessor 136, the graphics processor 144, the memory 138, and the data storage port 132 may be coupled and/or attached to the circuit board 126. According to one embodiment, several of the electronic components may be integrated into a system-on-chip (SoC). For example, the graphics processor 144, the microprocessor 136, and the memory 138 may be contained on a single SoC coupled and/or attached to the circuit board 126. According to one embodiment, the memory 138 may include 8 GB of flash memory.

The video recorder 122 may be a high definition (HD) video recorder capable of recording 1080 p and/or 720 p video at 30 frames per second. The video recorder 122 may alternatively be a standard definition video recorder limited to recording in lower resolutions, such as a video graphics array (VGA) resolution of 640×480. The video recorder 122 may be provided by Premier, Chicony, Ability, Foxlink, IAC, or the like. Although only one video recorder is illustrated in the eyeglasses 100, additional video recorders may be integrated with the eyeglasses 100. For example, a second video recorder (not shown) may be integrated in a corner of the eyeglasses opposite the video recorder 122 on the front frame 120. Video recorded from two video recorders may be combined to form a stereoscopic or three-dimensional video.

In another example, a second video recorder (not shown) may be located in a corner of the front frame 120 along with the video recorder, but oriented perpendicular to the video recorder to capture a wider angle of view. Additional video recorders (not shown) may be combined to generate panoramic images.

According to one embodiment, filters, shutters, or other devices may be attached to the video recorder 122. For example, a liquid crystal display (LCD) shutter (not shown) may be installed over the video recorder 122. The LCD shutter may reduce light entering the video recorder 122 enabling the camera to expose frames at quicker rates, such as every 1/60 second. The shutter reduces stuttering or strobing effects generating by rapidly changing scenes recorded by the video recorder 122. The shutter may introduce motion blur to the recorded video. Alternatively, algorithms implemented in the graphics processor 144, the microprocessor 136, or a device coupled to the eyeglasses 100 may introduce fake motion blur when large differences between frames in a recorded video are detected.

The battery 114 may be integrated with the left temple 116 and coupled to electronic components embedded in the right temple 118 of the eyeglasses 100 to provide power to the electronic components. For example, the battery 114 may be coupled to the video recorder 122, the circuit board 126, the integrated circuit 130, the audio recorder 134, the microprocessor 136, the internal memory 138, and the graphics processor 144. The battery 114 may be coupled to the electronic components of the eyeglasses 100 through the wire 140. The wire 140 may extend from the battery 114 on the left temple 116 through the frame front 120 to the right temple 118 through the hinges 128 that couple the temples 116 and 118 to the frame front 120.

According to one embodiment, the wire 140 may be embedded in the front frame 120 and the temples 116 and 118 with overmolding. For example, the wire 140 may be placed directly into an injection molding tool before hot liquid plastic is injected into the tool to form the front frame 120 and the temples 116 and 118. When the plastic is injected into the molding tool, the plastic flows around the wire 140 to embed the wire 140 into the frame 140 and the temples 116 and 118. Overmolding the wire 140 into the front frame 120 reduces space consumed by the wire 140, which reduces the increase in size of the eyeglasses 100 to accommodate the video recorder 122 and other electronic components. According to one embodiment, when the wire 140 is overmolded into the eyeglasses 100, the temples 116 and 118 may be as small or smaller than one quarter of an inch in width. Overmolding may also be applied to other electronic components of the eyeglasses 100. Overmolding components in the eyeglasses 100 reduces the size of the eyeglasses 100 and provides water resistance to protect the electronic components.

According to another embodiment, the wire 140 may be embedded in one or more channels (not shown), which are housed in the eyeglasses 100. After assembly of the channels into the eyeglasses 100, the channels may not be visible to the user. A combination of channels and overmolding may also be used for construction of the eyeglasses 100. For example, the wire 140 may be channeled in the front frame 120 and overmolded into the temples 116 and 118.

The video recorder 122 may be embedded in a corner between the front frame 120 and a butt end of the right temple 118. The butt end of the right temple 118 is the end of the temple 118 closest to the front frame 120. The lens 124 may cover the video recorder 122 to improve the quality of video and images obtained by the video recorder 122 and/or to protect the video recorder 122 from impact or water. The video recorder 122 may be coupled with other electronic components to provide streaming of data from the video recorder 122 to a wireless data connection, such as Bluetooth, WiFi, and/or a cellular data connection. For example, the video recorder 122 may be coupled to the graphics processor 144, the microprocessor 136, and the wireless transmitter 130. Either video or images may be transmitted from the video recorder 122 to the wireless transmitter 130.

In one example of video transmissions, data may be streamed from the video recorder 122 at high definition in a 220 Mbps stream with a resolution of 1280×720 to the graphics processor 144. The graphics processor 144 may encode and scale the video data into a particular video format, such as an H.264 video stream, and scale the video into a 0.5 Mbps stream with a resolution of 480×360. The encoded and scaled video stream from the graphics processor 144 may be transmitted to the microprocessor 136, which packages the data for transmission through the wireless transmitter 130. According to one embodiment, the wireless transmitter 130 transmits the data to a server (not shown) through a cellular data connection. According to another embodiment, the wireless transmitter 130 transmits the data to another device (not shown), which then transmits the data to a server. An audio recorder 134 coupled to the microprocessor 136 may be sampled nearly simultaneously with the encoded and scaled video stream by the microprocessor 136 and combined to generate an audio and video data stream.

In another example, the data from the video recorder 122 may be stored in the memory 138. When storing video in the memory 138, a user may be able to select between several options for quality of video recorded in the memory 138. The quality options may include, for example, a selection between high definition and standard definition recording. The standard definition option may store video at a resolution of 480×360. When storing data in standard definition, data may be stored through a similar process described above for streaming standard definition video, except the data is passed from the microprocessor 136 to the memory 138. When storing data in high definition, data may be streamed from the video recorder 122 at high definition in a 220 Mbps stream with a resolution of 1280×720 to the graphics processor 144. The graphics processor 144 may encode and scale the video data into a H.264 video stream at a resolution of 1280×720 with a data rate of 8 Mbps. The encoded and scaled video stream from the graphics processor 144 may be transmitted to the microprocessor 136, which stores the video stream in the memory 138. According to one embodiment, the microprocessor 136 may transmit the encoded and scaled video stream to the wireless transmitter 130, where the video stream is transmitted to another device for storage. Although storage and streaming of the video are discussed separately above, the processes may operate simultaneously, such that the video is streamed through the wireless transmitter 130 and stored in the memory 138 simultaneously.

The data storage port 132 may provide a communications path to another device through a wired connection. For example, the data storage port 132 may be a micro universal serial bus (USB) or mini-USB connector. The data storage port 132 may connect the eyeglasses 100 to another device through a USB cable and provide an interface to access data in the memory 138. Another device connected to the eyeglasses 100 through the data storage port 132 may access video and images stored in the memory 138 through a file system. The video and images may be stored in the memory 138 as AVI, JPEG, MPEG files, or in other suitable file formats. According to one embodiment, data may be streamed from the video recorder 122 to the data storage port 132 and to another device. For example, the eyeglasses 100 may act as a webcam during a video call or video conference. According to another embodiment, data may be streamed from the video recorder 122 to a television or projector through the data storage port 132 according to the mobile high definition link (MHL) standard, or another suitable standard. The data storage port 132 may further provide recharging capability to charge the battery 114.

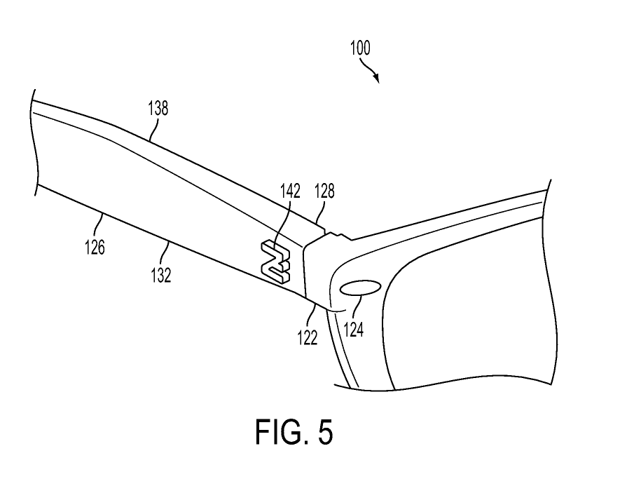

Referring to FIG. 5, a button 142 may be attached to the right temple 118. The button 142 may be coupled to the electronic components through the circuit board 126 to control the video recorder 122. For example, the button 142 may be pressed once to start video recording and/or streaming and pressed a second time to stop video recording and/or streaming. Other commands may be implemented based on a number of sequential depressions of the button 142 or a delay during depression of the button 142. For example, pressing the button 142 twice in rapid succession may cause subsequent recordings to occur in high definition. In another example, depressing the button 142 for three seconds may cause the eyeglasses 100 to turn off. Although only one button 142 is illustrated, additional buttons may be included on the eyeglasses 100. For example, separate record and power buttons may be located on the eyeglasses 100.

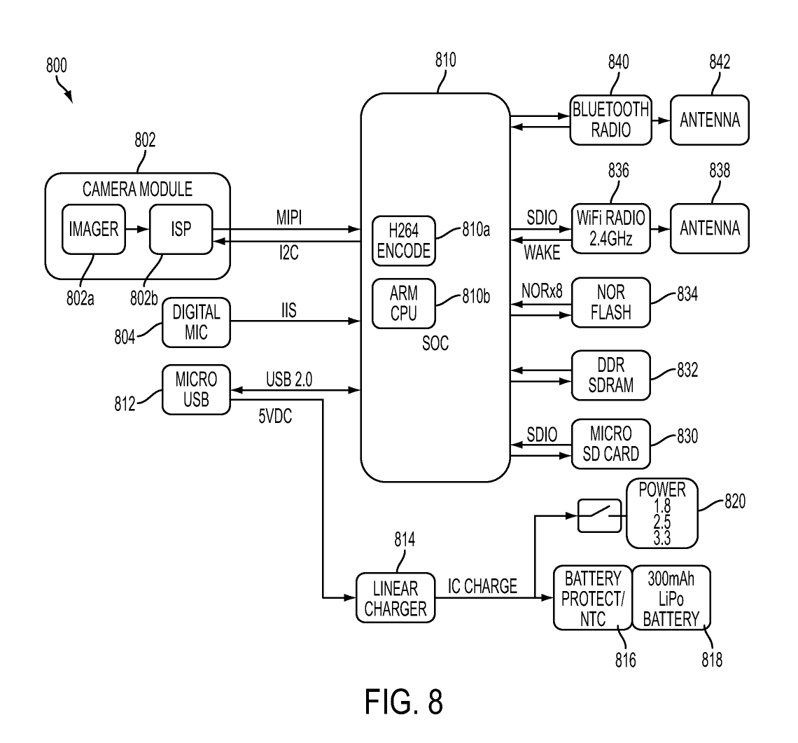

FIG. 8 is a block diagram illustrating electronics for eyeglasses with an integrated camera according to one embodiment of the disclosure. A camera system 800 includes a camera module 802 having an imager 802a and an integrated single processor (ISP) 802b. The camera module 802 may be coupled to an SoC 810 having H.264 encoding circuitry 810a and a central processor unit (CPU) 810b, such as an advanced RISC machine (ARM) CPU. The ARM CPU may be provided by, for example, the Texas Instruments OMAP4 processor, a Broadcom BCM2727 processor, a Marvell MMP2 processor, an Ambarella A5s processor, a Samsung S5PC9xxx processor, and/or a Sunplus processor. The SoC 810 may also be coupled to a digital microphone 804 and a micro universal serial bus (USB) connector 812. Other electronic components, such as a micro secure digital (SD) card 830, RAM 832, flash memory 834, a first wireless radio 836 and antenna 838, and a second wireless radio 840 and antenna 842 may be coupled to the SoC 810. According to one embodiment, certain other electronic components may be integrated into the SoC 810. For example, the radios 836 and 840 may be part of the SoC 810. The micro USB connector 812 may also provide power to the camera system 800. That is, the data portion of the USB connector 812 may be routed to the SoC 810, and the 5 Volt DC portion may be routed to a linear charger 814. The charger 814 may be coupled to a battery 818 through a battery protect circuit 816. The battery 818 may have a capacity of approximately 270 milliampere-hours (mAh). A switch 820 may be coupled to the charger 814 to automatically switch between 1.8 Volt, 2.5 Volt, and 3.3 Volt operation.

### Operation with Wireless Connections

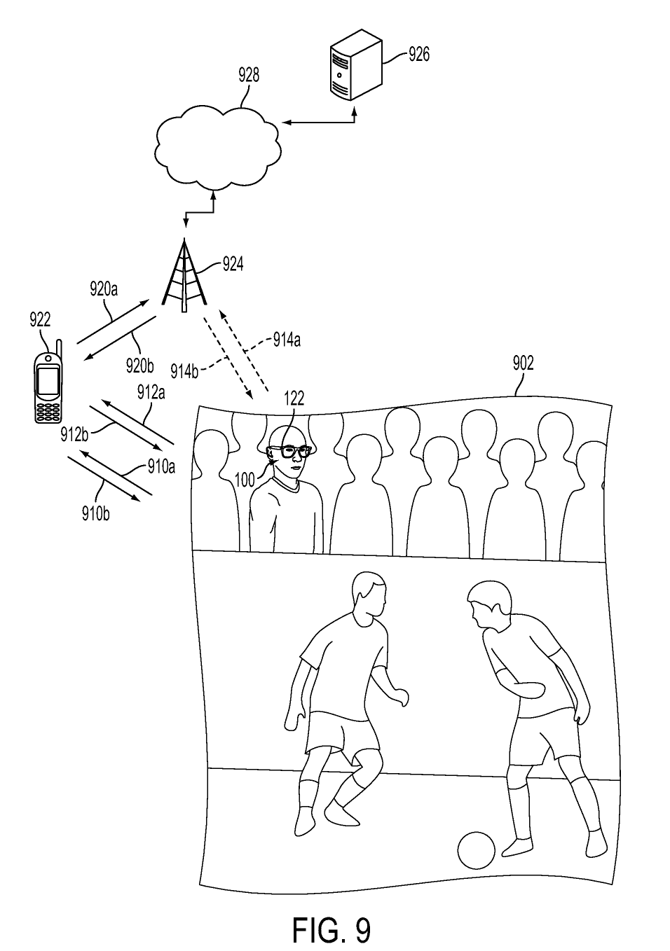

As described above, the eyeglasses 100 of FIG. 1 may be used to stream video or image data to servers for viewing by other users and/or storage. FIG. 9 is a block diagram illustrating a wireless connection between eyeglasses with an integrated camera and a cellular phone according to one embodiment of the disclosure. The eyeglasses 100, including integrated camera 122, may be worn by a participant at an event 902, such as a soccer match. The eyeglasses 100 may communicate with a mobile device 922, such as a cellular phone or laptop computer, through one or more wireless communications connections. For example, the eyeglasses 100 may communicate with the mobile device 922 through a Bluetooth connection 910a-b and/or a WiFi connection 912a-b. Communications over the Bluetooth connection 910a-b may establish a link between the eyeglasses 100 and the mobile device 922 and provide a pathway for commands. For example, the mobile device 922 may issue “start recording” and “stop recording” commands to the eyeglasses 100 over the Bluetooth connection 910a-b. Communications over the WiFi connection 912a-b may include video and/or images from the integrated camera 122 of the eyeglasses 100. However, the Bluetooth connection 910a-b is not restricted to commands and the WiFi connection 912a-b is not restricted to video and images. Video and images may also be transmitted over the Bluetooth connection 910a-b and commands may be transmitted over the WiFi connection 912a-b. For example, where the WiFi connection 912a-b is already established and transmitting streaming video, commands may also be routed over the WiFi connection 912a-b to allow the Bluetooth connection 910a-b to be temporarily disconnected. In another example, where the integrated camera 122 is capture low resolution still images, the images may be transferred over the Bluetooth connection 910a-b to reduce power consumption associated with the WiFi connection 912a-b.

The mobile device 922 may be connected to an access point 924 through a connection 920a-b. The access point 924 may be, for example, a cellular phone base station or a WiFi router. The access point 924 may provide access to a server 926 through a network 928, such as the Internet. Thus, streaming video may be relayed from the integrated camera 122 of the eyeglasses 100 through one of the connections 910a-b and 912a-b to the mobile device 922, and through the connection 920a-b to the server 926 on the network 928. The server 926 may allow other users on the network 928 to view the video stream from the integrated camera 122 of the eyeglasses 100.

According to one embodiment, the eyeglasses 100 may include a wireless radio for communication on a wireless connection 914a-b, such as a 3G/4G cellular data network radio. The eyeglasses 100 may stream video from the integrated camera 122 to the server 926 without the use of the mobile device 922. The wireless connection 914a-b may also be a WiFi connection for allowing the eyeglasses 100 to stream to the server 926. According to one embodiment, the mobile device 922 initiates a WiFi connection directly with the eyeglasses 100. According to another embodiment, the mobile device 922 initiates a Bluetooth connection with the eyeglasses 100 to provide security credentials for a WiFi connection, after which the mobile device 922 initiates a WiFi connection with the eyeglasses 100 using the security credentials.

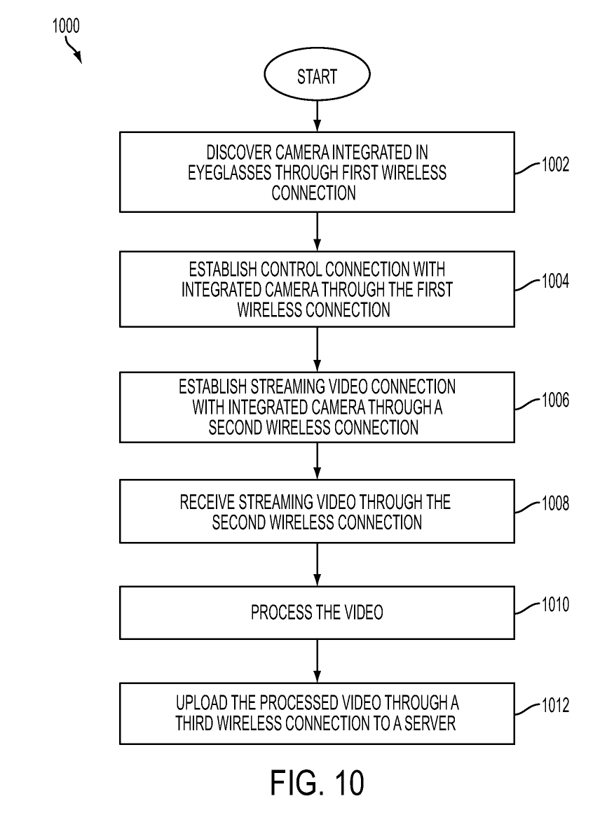

The eyeglasses 100 may use two connections to the mobile device 922 for communications. FIG. 10 is a flow chart illustrating a method of connecting and transferring video from eyeglasses with an integrated camera to a cellular phone according to one embodiment of the disclosure. A method 1000 begins at block 1002 with the mobile device 922 discovering the integrated camera 122 of the eyeglasses 100 through a first wireless connection, such as the Bluetooth connection 910a-b. For example, the mobile device 922 may perform discovery to determine the eyeglasses 100 are nearby. At block 1004, the mobile device 922 proceeds to establish a control connection with the eyeglasses 100 through the first wireless connection. For example, the mobile device 922 may pair with the eyeglasses 100.

At block 1006, the mobile device 922 may establish a streaming video connection with the eyeglasses 100 over a second wireless connection, which may be the same as the first wireless connection. For example, the mobile device 922 may establish the WiFi connection 912a-b with the eyeglasses 100. The mobile device 922 may control the operation of the eyeglasses 100 on the WiFi connection 912a-b through the Bluetooth connection 910a-b. For example, the mobile device 922 may create an ad hoc WiFi network and provide a host name to the eyeglasses 100 through the Bluetooth connection 910a-b. After establishing the second wireless connection, the eyeglasses 100 may stream video through the second wireless connection at block 1008. The second wireless connection may be established at the request of the user. The request may be received through the control connection or a graphical user interface on the mobile device.

When the first wireless connection consumes less power than the second wireless connection, the communication method illustrated in FIG. 10 provides advantages such as improved battery life in the eyeglasses 100. That is, the eyeglasses 100 may remain connected to the mobile device 922 and remain ready to receive and process commands without maintaining the higher power connection of the second wireless connection. After video streaming has completed, the higher power and higher bandwidth second wireless connection may be disconnected, but the eyeglasses 100 remain ready to begin streaming video to the mobile device 922 again.

While the mobile device 922 receives streaming video through the second wireless channel at block 1008, the mobile device 922 may perform processing on the video at block 1010. For example, the mobile device 922 may perform scaling and/or encoding of the video to an appropriate format for transfer to the server 926. In another example, the mobile device 922 may perform lighting or color modification, such as conversion to black and white video. In yet another example, processing may include overlaying text information on the image, such as a date and time or a title. The information attached to the video during processing may also include non-visual information, such as global positioning system (GPS) data embedded in the video stream to identify a location where the video was recorded. At block 1012, the processed video of block 1010 may be uploaded to a server through a third wireless connection. For example, the mobile device 922 may upload the processed video to the server 926 through a 3G/4G cellular data connection 920a-b.

In addition to the processed video uploaded to a server at block 1012, the mobile device may transmit authentication information, such as a user name and password, associated with a user of the eyeglasses. The authentication information may be used by the server to securely store the processed video. Further, security restriction information may be uploaded along with the processed video at block 1012. The security restriction information may identify one or more other users identified as allowed to view and/or modify the uploaded video. For example, the security restriction information may include a tag labeled “Friends,” which indicates that any other user labeled as a friend to the user identified by the authentication information may view the uploaded video. The security restriction information may also be automatically identified by the mobile device. For example, video taken during a Saturday afternoon may automatically be tagged with a label “Soccer Friends,” and users previously associated with this group may be allowed access to the uploaded video.

The mobile device 922 may include one or more software applications for performing the method described in FIG. 10. For example, when the mobile device 922 is a cellular phone, an application may be available for the cellular phone to control the eyeglasses 100. The application may include an interface for selecting a video quality of the integrated camera 122, selecting a server for uploading video from the integrated camera 122, activating and deactivating the integrated camera 122, programming a scheduled time for activating and deactivating the integrated camera 122, selecting options for processing video received from the integrated camera 122, selecting options for processing of the video by electronic components in the eyeglasses 100 before transferring the video to the mobile device 922, and/or a selecting streaming or local storage mode for the eyeglasses 100.

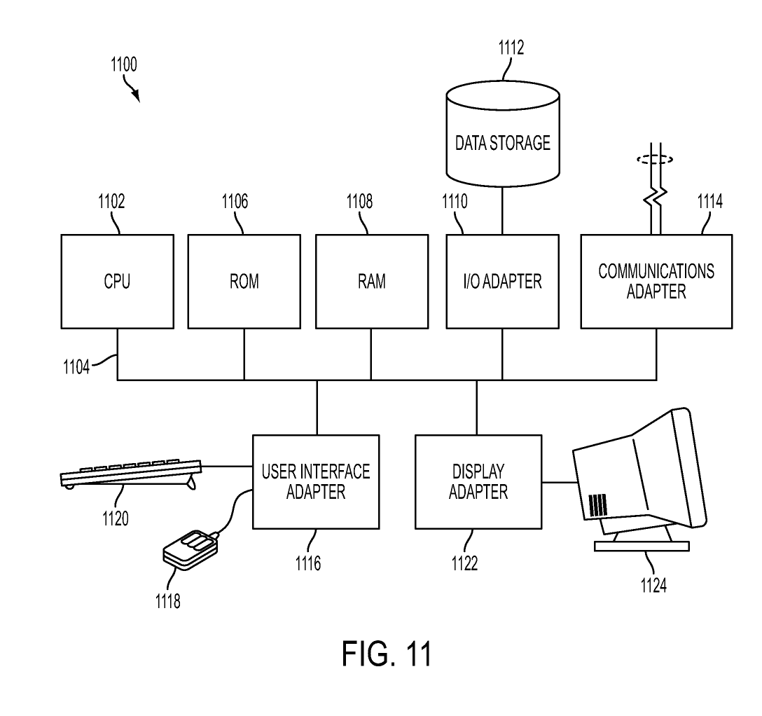

FIG. 11 illustrates a computer system 1100 adapted according to certain embodiments of the mobile device 922, such as a cellular phone or a laptop computer. A central processing unit (“CPU”) 1102 is coupled to a system bus 1104. The CPU 1102 may be a general purpose CPU or microprocessor, graphics processing unit (“GPU”), and/or microcontroller. The present embodiments are not restricted by the architecture of the CPU 1102 so long as the CPU 1102, whether directly or indirectly, supports the modules and operations as described herein. The CPU 1102 may execute the various logical instructions according to the present embodiments.

The computer system 1100 also may include random access memory (RAM) 1108, which may be synchronous RAM (SRAM), dynamic RAM (DRAM), and/or synchronous dynamic RAM (SDRAM), or the like. The computer system 1100 may use RAM 608 to store the various data structures used by a software application. The computer system 1100 may also include read only memory (ROM) 1106, which may be PROM, EPROM, EEPROM, optical storage, or the like. The ROM 1106 may store configuration information for booting the computer system 1100. The RAM 1108 and the ROM 1106 may store user and system data.

The computer system 1100 may also include an input/output (I/O) adapter 1110, a communications adapter 1114, a user interface adapter 1116, and a display adapter 1122. The I/O adapter 1110 and/or the user interface adapter 1116 may, in certain embodiments, enable a user to interact with the computer system 1100. In a further embodiment, the display adapter 1122 may display a graphical user interface (GUI) associated with a software or web-based application on a display device 1124, such as a monitor or touch screen.

The I/O adapter 1110 may couple one or more storage devices 1112, such as one or more of a hard drive, a solid state storage device, a flash drive, a compact disc (CD) drive, a floppy disk drive, or a secure digital card, to the computer system 1100. According to one embodiment, the data storage 1112 may be a separate server coupled to the computer system 600 through a network connection to the I/O adapter 1110. The communications adapter 1114 may be adapted to couple the computer system 1100 to a network, which may be one or more of a LAN, WAN, and/or the Internet. The communications adapter 1114 may also be adapted to couple the computer system 1100 to other networks such as a global positioning system (GPS) or a Bluetooth network. The user interface adapter 1116 couples user input devices, such as a keyboard 1120, a pointing device 1118, and/or a touch screen (not shown) to the computer system 1100. The keyboard 1120 may be an on-screen keyboard displayed on a touch panel. Additional devices (not shown) such as a camera, microphone, video camera, accelerometer, compass, and/or a gyroscope may be coupled to the user interface adapter 1116. The display adapter 1122 may be driven by the CPU 1102 to control the display on the display device 1124.

The applications of the present disclosure are not limited to the architecture of computer system 1100. Rather the computer system 1100 is provided as an example of one type of computing device that may be adapted to perform the functions of the mobile device 922. For example, any suitable processor-based device may be use including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may use any number of suitable structures capable of executing logical operations according to the described embodiments.

### Camera Control with Hand Motions

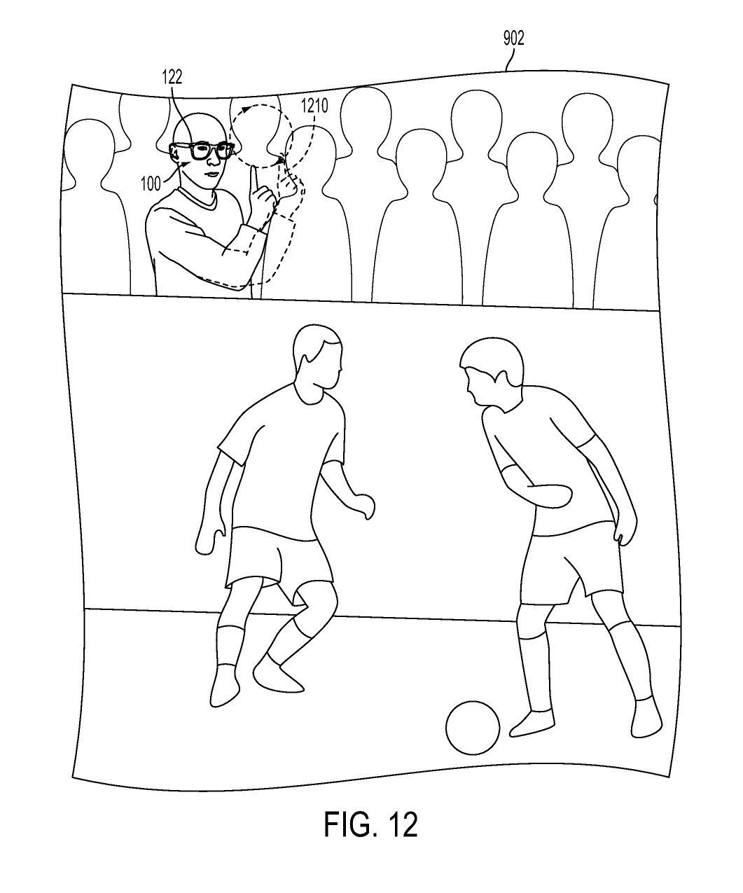

The integrated camera 122 of the eyeglasses may be controlled through a mobile device as described above or through controls on the eyeglasses 100. The integrated camera 122 may also be controlled through hand gestures by a wearer of the eyeglasses 100 or a nearby person. FIG. 12 is a drawing illustrating a method of controlling a video camera integrated into eyeglasses according to one embodiment of the disclosure. A user wearing the eyeglasses 100 at the event 902 may use his hand 1210 to control the eyeglasses 100. For example, a user may move his hand 1210 in a circular shape, similar to a record symbol, to instruct the eyeglasses 100 to begin recording video. In another example, a user may move his hand 1210 in a square shape, similar to a stop symbol, to instruct the eyeglasses 100 to stop recording video.

Hand motions for controlling the eyeglasses 100 further improve the ability of the wearer of the eyeglasses 100 at the event 902 to participate in the event 902 rather than merely become a spectator at the event 902. By using hand motions, the participant may control the eyeglasses 100 without locating and interacting with their mobile device. Even when the mobile device is a cellular phone, controlling the eyeglasses 100 would require reaching into a pocket, obtaining the cellular phone, unlocking the cellular phone by entering a password, launching the correct application, and activating the correct control in the application to carry out a function on the eyeglasses 100.

For example, if an individual is participating in a soccer match and recording the soccer match with the eyeglasses 100, then the individual would have to be removed from play in order to control the eyeglasses 100. The ten to fifteen seconds of the player's attention required to control the eyeglasses 100 may prevent the individual from participating in the soccer match. Instead, a hand motion can be performed without the individual stopping participation in the soccer match.

Hand motions, such as those illustrated in FIG. 12, may also be used by an individual to mark events in the recorded video. For example, in a soccer match when an individual sees a goal scored, then the individual may use a hand motion in the shape of a “G,” which is recognized by the integrated camera 122 or a connected mobile device. The video generated by the integrated camera 122 may then be marked with events to allow quick access to particular events in a video file. In another example, generic tags in a video stream may be marked when an individual uses a hand motion in the shape of a plus sign.

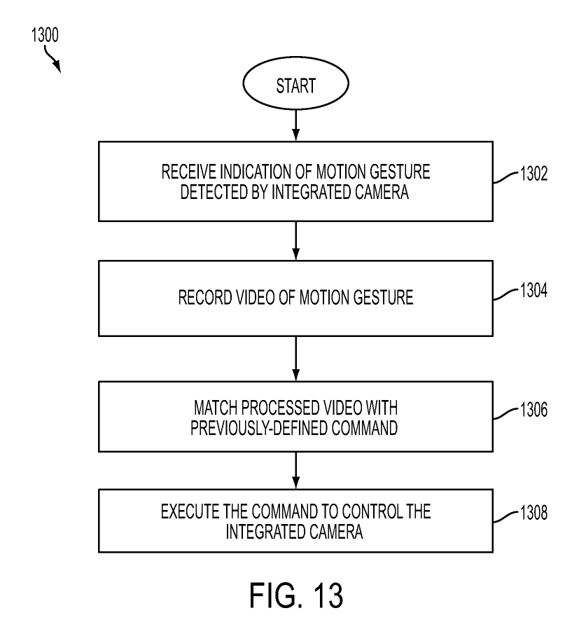

Processing of hand motions may be performed by electronic components in the eyeglasses 100 or on a mobile device connected to the eyeglasses 100. FIG. 13 is a flow chart illustrating a method of controlling a video camera integrated into eyeglasses according to one embodiment of the disclosure. A method 1300 begins at block 1302 with receiving an indication of a motion gesture detected by an integrated camera. In a situation where the integrated camera is not currently recording, the camera may include a motion-detection algorithm to detect the start of a hand motion with a short range of the integrated camera. At block 1304, the video of the hand motion is recorded. When a motion-detection algorithm started the recording, the same algorithm may be used to detect when the hand motion has completed and turn off the integrated camera. According to one embodiment, the video at block 1304 may be transferred to a mobile device for matching at block 1326. At block 1306, the video-recorded hand motion may be compared with previously-defined hand motions to identify a command. At block 1308, the identified command is executed to control the integrated camera. For example, streaming video from the integrated camera may be started or stopped upon the detection of a circle or a square hand motion, respectively.

### Presentation Control with Hand Motions

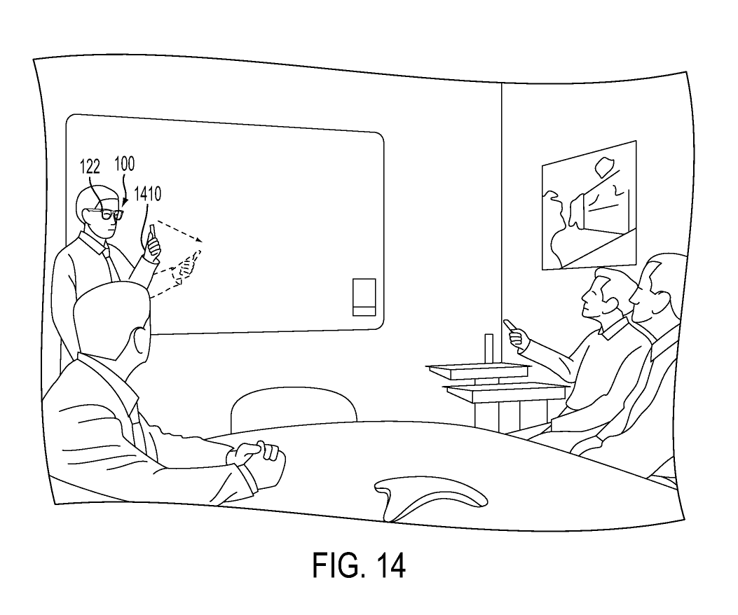

In addition to controlling streaming and recording of video by the integrated camera and tagging events in a video stream, hand motions performed within the sight of the integrated camera may be used to control other devices. For example, hand motions may be used to control a presentation. FIG. 14 is a drawing illustrating a method of controlling a video presentation through a video camera integrated into eyeglasses according to one embodiment of the disclosure. A presenter wearing the eyeglasses 100 may use his hand 1410 to perform a hand motion in front of the integrated camera 122. For example, the presenter may swipe his hand 1410 to the right to issue a command to advance to the next slide in a slide show presentation. In another example, the presenter may swipe his hand 1410 to the left to issue a command to move to the previous slide in a slide show presentation.

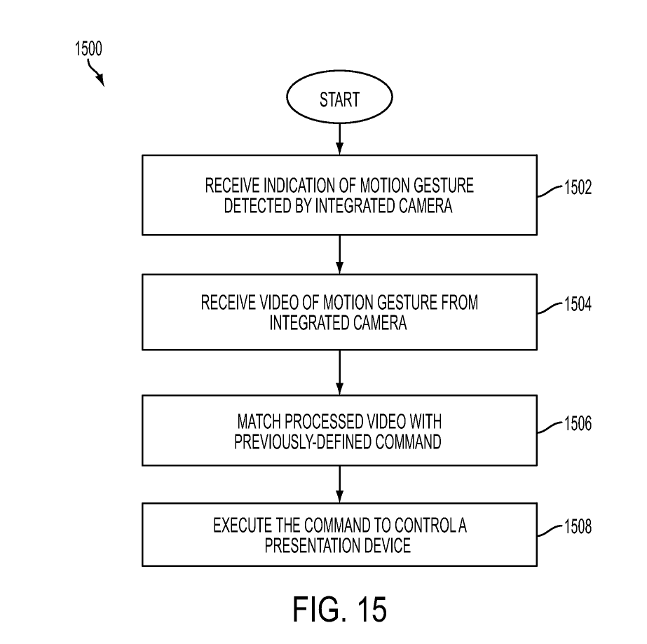

Processing of hand motions may be performed by electronic components in the eyeglasses 100 or on a mobile device communicating with the eyeglasses 100. FIG. 15 is a flow chart illustrating a method of controlling a video presentation through a video camera integrated into eyeglasses according to one embodiment of the disclosure. A method 1500 begins at block 1502 with receiving an indication of a motion gesture detected by an integrated camera. In a situation where the integrated camera is not currently recording, the camera may include a motion-detection algorithm to detect the start of a hand motion with a short range of the integrated camera. At block 1504, the video of the hand motion is recorded. When a motion-detection algorithm started the recording, the same algorithm may be used to detect when the hand motion has completed and turn off the integrated camera. At block 1506, the video-recorded hand motion may be compared with previously-defined hand motions to identify a command. At block 1508, the identified command is executed to control the presentation device. For example, a slide show presentation may be advanced.

According to one embodiment, the processing of video to match commands at block 1508 may be performed by electronic components of the eyeglasses. After the command is identified, the command may be communicated to the presentation device or a mobile device coupled to the presentation device through a low-power wireless communications connection, such as Bluetooth.

According to another embodiment, the processing of video to match commands at block 1508 may be performed by the presentation device or a mobile device communicating with the presentation device. The indication of block 1502 may be received by the presentation device through a low-power wireless communications connection, such as Bluetooth. After receiving the indication at block 1502, a high-bandwidth wireless connection, such as WiFi may be established between the presentation device and the eyeglasses. Then at block 1504, the video may be received through the high-bandwidth wireless connection and processed at block 1508 by the presentation device.

### Obtaining Product Information Through Eyeglasses with an Integrated Camera

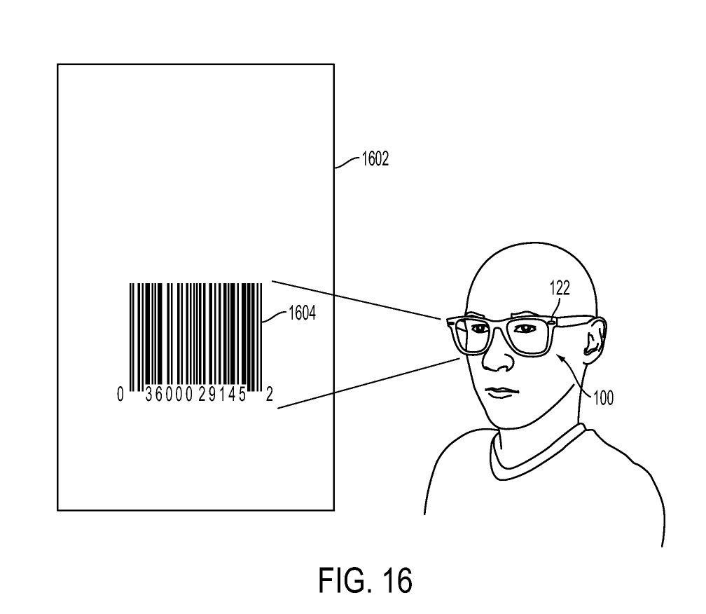

Images recorded with the integrated camera 122 of the eyeglasses 100 may be used to provide timely and relevant information to a user wearing the eyeglasses 100. FIG. 16 is a drawing illustrating a method of analyzing product information with a video camera integrated into eyeglasses according to one embodiment of the disclosure. A product packaging 1602 having a label 1604, such as a UPC bar code or a QR code, may come within the field of view of the integrated camera 122. The integrated camera 122 may capture an image of the product packaging 1602 automatically upon detection of a UPC bar code or manually upon activation of a control on the eyeglasses 100. The eyeglasses 100 then cooperate with a nearby mobile device, such as the user's cellular phone, to provide additional information to the user.

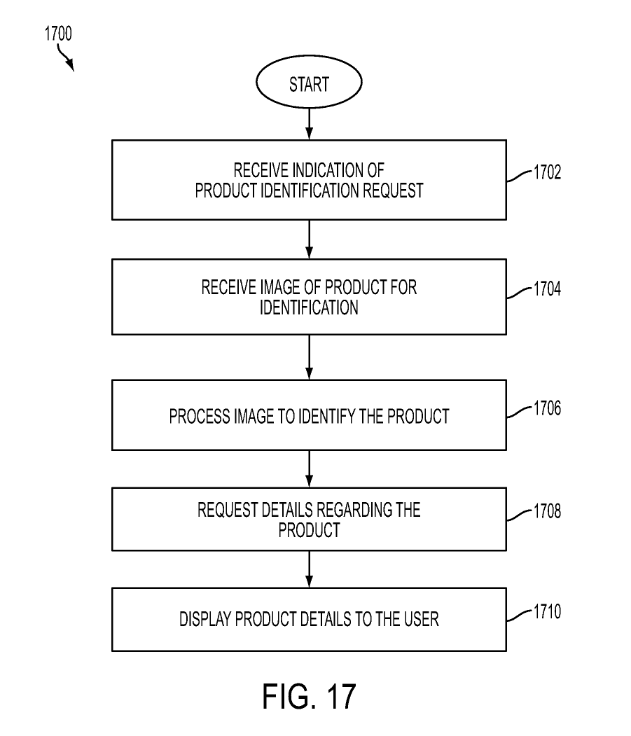

FIG. 17 is a flow chart illustrating a method of analyzing product information with a video camera integrated into eyeglasses according to one embodiment of the disclosure. A method 1700 begins at a block 1702 when an indication is received from the eyeglasses of a product identification request. The request may be made through activation of a control on the eyeglasses or automatically when a microprocessor in the eyeglasses recognizes a UPC bar code or the like. The indication generated by the request may be a communication signal transmitted over a low-power wireless connection, such as Bluetooth, to a cellular phone. In another example, the indication is received by a module executing on the microprocessor in the eyeglasses.

At block 1704, an image of the product for identification is received. The image may be transmitted from the eyeglasses to the cellular phone through a high-bandwidth wireless connection, such as Wi-Fi. In another example, the image is transferred over an internal bus from the integrated camera to a microprocessor in the eyeglasses.

At block 1706, the image is processed to identify the product. Identifying the product may include processing at the eyeglasses or the cellular phone. For example, the image may be cropped automatically to reduce the image size to prominently display the UPC bar code. The UPC bar code may then be transmitted from the cellular phone or the eyeglasses to a server to match the UPC bar code with a product. The product may be returned to the eyeglasses or the cellular phone.

At block 1708, the product label is used to request additional product details and display the product details to the user at block 1710. For example, once a product is identified as a home stereo speaker, additional information may be retrieved from Wikipedia regarding speakers and displayed to the user. In another example, once a product is identified as a home stereo speaker, additional information regarding the specific model captured by the integrated camera is displayed to the user along with a comparison of prices and review from several online and local stores. According to one embodiment, information about a user's location is combined with the image of the product received at block 1704 to obtain additional product details at block 1708.

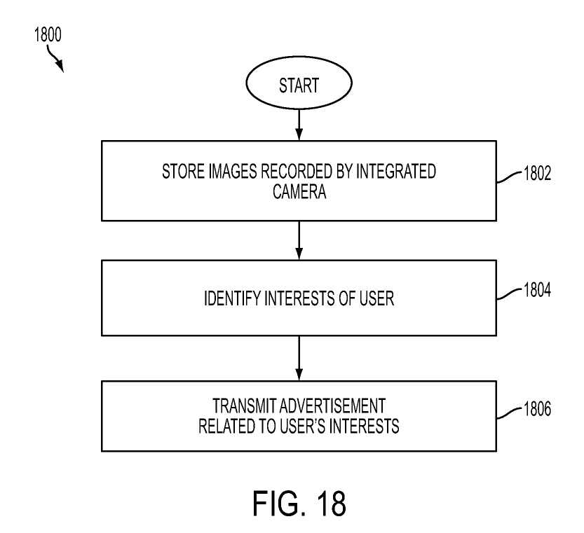

The product information requested at block 1708 may be accumulated and used to provide advertisements to the user. FIG. 18 is a flow chart illustrating a method of providing advertisements to a user based on images captured by a camera integrated into eyeglasses according to one embodiment of the disclosure. A method 1800 begins at block 1802 with storing images recorded by an integrated camera. The images may be stored in response to requests for product information, as described above in the method 1700 of FIG. 17. The images may also be collected from video or images recorded by the integrated camera for streaming. The images may further be collected at randomized intervals, such as every hour or upon detection of a particular motion of the eyeglasses.

At block 1804, interests of the user may be identified from the images stored at block 1802. For example, when many images recorded at block 1802 include home theatres, an interest in home theatres may be identified. In another example, when many images recorded at block 1804 include sports cars, an interest in cars may be identified.

At block 1806, advertisements related to the user's interests are transmitted to the user's mobile device. For example, when cars are identified as an interest at block 1804, car dealership advertisements may be transmitted to the user's mobile device. In another example, when a specific make and model of a car are identified as an interest at block 1804, car dealerships offering that specific make and model of the car may transmit advertisements for deals on that specific make and model of the car.

### Additional Applications for Eyeglasses with an Integrated Camera

Many industries, other than consumer industries, may benefit from eyeglasses with an integrated camera. For example, on-duty police offers, military officials, and construction foremen may wear eyeglasses with an integrated camera allowing supervisors to ensure employees are carrying out their duties correctly. Police offers may wear eyeglasses with integrated cameras during operations or traffic stops to obtain evidence for use during later criminal proceedings. Military officials may wear eyeglasses with integrated cameras during field operations to provide near real-time geographical and intelligence data to a command station.

In another example, surgeons may wear the eyeglasses with an integrated camera to record surgical operations. The video recording may later be used as evidence in a malpractice hearing to demonstrate the surgeon acted according to customary norms for safety. When a surgeon volunteers to wear the eyeglasses with an integrated camera during operations, an insurance company may offer the surgeon reduced malpractice insurance rates if the video is streamed from the eyeglasses to the insurance company's servers for record-keeping.

In yet another situation airline pilots may wear the eyeglasses with an integrate camera to record flight operations. For example, the eyeglasses may be used to record activities in the cockpit during the entire flight and streamed to air traffic controllers on the ground. In another example, the eyeglasses may be used to record activities during landing and takeoff or when activated because an emergency condition has occurred. When an emergency occurs, the video streamed from the eyeglasses may be recorded to a black box flight data recorder in the airplane to provide emergency responders with information about cockpit activities during the emergency.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Under general usage, disk and disc includes compact discs (CD), laser discs, optical discs, digital versatile discs (DVD), floppy disks, and blu-ray discs. Disks reproduce data magnetically, and discs reproduce data optically. Combinations of the above may also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An apparatus, comprising:
an eyeglasses frame having a first temple and a second temple, the first and second temple attached to a front frame through a first and second hinge;
a video recorder integrated into the front frame;
electronic components coupled to the video recorder and attached to the first temple and the second temple;
a wire coupling electronic components in the first temple with electronic components in the second temple, the wire running through the first temple, the first hinge, the front frame, the second hinge, and the second temple,
in which the wire is overmolded into at least the front frame.

2. The apparatus of claim 1, in which the electronic components comprise a battery, a microprocessor, a graphics processor, and a first wireless transmitter.

3. The apparatus of claim 2, in which the battery is attached to the first temple and the microprocessor is attached to the second temple.

4. The apparatus of claim 2, in which at least one of the electronic components is overmolded into the second temple.

5. The apparatus of claim 2, in which the microprocessor and the graphics processor are part of a system-on-chip (SoC).

6. The apparatus of claim 2, in which the electronic components further comprise a second wireless transmitter.

7. The apparatus of claim 2, in which the microprocessor is configured:
to capture at least one video or at least one image from the video recorder; and
to transmit the video or the image through the first wireless transmitter.

8. The apparatus of claim 7, in which the electronic components further comprise a second wireless transmitter, in which the microprocessor is configured to establish a connection with a mobile device through the second wireless transmitter before transmitting the video or the image through the first wireless transmitter.

9. The apparatus of claim 7, in which the first wireless transmitter is a cellular data network radio.

10. The apparatus of claim 7, in which the microprocessor is configured to process the video or the image from the video recorder with the graphics processor before transmitting through the first wireless transmitter.

11. The apparatus of claim 1, further comprising a liquid crystal display (LCD) shutter coupled to the video recorder.

12. A method, comprising:
establishing communications over a first wireless connection between a mobile device and eyeglasses with an integrated camera;
establishing communications over a second wireless connection between the mobile device and the eyeglasses by communicating through the first wireless connection; and
transmitting a video or an image through the second wireless connection from the eyeglasses to the mobile device.

13. The method of claim 12, in which the first wireless connection is a low-power wireless connection, and the second wireless connection is a high-bandwidth wireless connection.

14. The method of claim 12, further comprising uploading the video or the image to a server through a third wireless connection.

15. The method of claim 14, further comprising processing the video or the image before uploading the video or the image.

16. The method of claim 14, further comprising transmitting user authentication information to identify a user associated with the video or the image.

17. The method of claim 16, further comprising transmitting security restriction information to identify one or more viewers allowed to view the video or the image.

18. The method of claim 12, in which the third wireless connection is a cellular data network.

19. The method of claim 12, further comprising requesting product details for a product contained in the video or the image.

20. The method of claim 19, further comprising:
displaying the product details; and
displaying an advertisement related to the product.
